(19) United States
(12) Patent Application Publication
(10) Pub. No.: US 2004/0234833 A1
(43) Pub. Date: Nov. 25, 2004

(54) Humidification cell

(76) Inventors: Herbert Hartnack, Erlangen (DE); Josef Lersch, Heroldsbach (DE); Arno Mattejat, Bubenreuth (DE)

Correspondence Address: HARNESS, DICKEY & PIERCE, P.L.C., P.O.BOX 8910, RESTON, VA, 20195, US

(21) Appl. No.: 10/491,101

(22) PCT Filed: Sep. 16, 2002
(86) PCT No.: PCT/EP02/10372

(30) Foreign Application Priority Data
Sep. 27, 2001 (EP) 01123170.1

(51) Int. Cl. H01M 8/04; H01M 8/10; H01M 4/96

(52) U.S. Cl. 429/32; 429/44

(57) ABSTRACT

The invention relates to a humidification cell (1) of a fuel cell assembly (41), comprising a water-permeable membrane (5) located between two external plates (9) of said humidification cell (1). One section of the surface of the membrane (5) is fitted to at least one of the external plates (9) and is thus partially covered by the external plate (9). This reduces the humidification capability of the membrane (5). To solve this problem, the inventive humidification cell (1) has a water-permeable supporting element (7a, 7b), which is located between the membrane (5) and one of the external plates (9).

The invention relates to a humidification cell of a fuel cell apparatus with two outer plates, between which a gas space, a humidification water space and a water-permeable membrane separating the two spaces are arranged.

In a fuel cell, electrochemical combining of hydrogen (H₂) and oxygen (O₂) at an electrolyte to form water (H₂O) generates electric current with a high level of efficiency and, if the fuel gas used is pure hydrogen, without the emission of pollutants and carbon dioxide (CO₂). Technical implementation of this principle of the fuel cell has led to various solutions, specifically with different types of electrolyte and with operating temperatures between 60° C. and 1000° C. Depending on their operating temperature, the fuel cells are classified as low-temperature, medium-temperature and high-temperature fuel cells, which are in turn different from one another by virtue of differing technical embodiments.

A single fuel cell supplies an operating voltage of at most approximately 1.1 V. Therefore, a large number of fuel cells are connected up to form a fuel cell assembly, for example to form a stack of planar fuel cells which forms part of a fuel cell block. Connecting the fuel cells of the assembly in series makes it possible to achieve an operating voltage of the assembly of 100 V and above.

A planar fuel cell comprises a flat electrolyte, one flat side of which is adjoined by a flat anode and the other flat side of which is adjoined by a likewise flat cathode. These two electrodes, together with the electrolyte, form what is known as an electrolyte-electrode assembly, which is also referred to below as an electrolyte assembly, for the sake of simplicity. An anode gas space adjoins the anode, and a cathode gas space adjoins the cathode. An interconnector plate is arranged between the anode gas space of one fuel cell and the cathode gas space of a fuel cell which adjoins this fuel cell. The interconnector plate produces an electrical connection between the anode of the first fuel cell and the cathode of the second fuel cell. Depending on the type of fuel cell, the interconnector plate is configured, for example, as an individual metallic plate or as a cooling element which comprises two plates stacked on top of one another with a cooling water space between them. Depending on the particular embodiment of the fuel cells, further components, such as for example electrically conductive layers, seals or pressure cushions, may also be located within a fuel cell stack.

While they are operating, the fuel cells of a fuel cell assembly are supplied with operating gases, i.e. a hydrogen-containing fuel gas and an oxygen-containing oxidation gas. Some embodiments of low-temperature fuel cells, in particular fuel cells with a polymer electrolyte membrane (PEM fuel cells), require humidified operating gases for them to operate. These operating gases are saturated with steam in a suitable device, such as for example a liquid ring compressor or a membrane humidifier. The humidification device and any further supply devices together with the fuel cell assembly form the fuel cell apparatus.

If the operating gases are passed through long operating-gas feed lines from the humidifier to the fuel cell assembly, the temperature of a humidified operating gas may drop as a result of the loss of heat to the environment.

This leads to the condensation of humidification water. The operating gases are then reheated in the fuel cells, with the result that their relative moisture content drops. As a result, the electrolyte, which is always to be kept moist and is extremely sensitive to drying out, has its service life reduced. It is therefore desirable for the humidifier to be arranged as close as possible to the fuel cells.

Patents U.S. Pat. No. 5,200,278 and U.S. Pat. No. 5,382,478 have disclosed a fuel cell block having a stack of planar fuel cells and a stack of planar humidification cells. The two stacks are arranged directly adjacent to one another in the fuel cell block. The humidification cells are designed as membrane humidifiers with an operating gas space, a humidification water space and a water-permeable membrane arranged between the two spaces. Before the operating gases are fed to the fuel cells of the fuel cell stack, they flow through the humidification cells, where they are humidified and then flow into the fuel cell stack without leaving the fuel cell block. In the humidification cells, the water-permeable membrane directly adjoins the outer plates, arranged on both sides of the membrane, of the humidification cells. The humidification water flows on one side of the membrane, and the operating gas flows on the other side of the membrane, through passages which are machined into the respective outer plate. Along the webs of the outer plates, however, the membrane is covered by the webs, so that it is impossible for any humidification water or operating gas to reach the membrane. In this way, the humidification capacity of the membrane is reduced compared to the membrane which is freely accessible to the humidification water. When large-area structures are used in the outer plate, the membrane bears against the outer plate over a large area, with the result that the humidification capacity is greatly reduced.

The object of the present invention is to provide a humidification cell for a fuel cell apparatus which has a high humidification capacity.

This object is achieved by a humidification cell of the type described in the introduction which, in accordance with the invention, has a water-permeable supporting element arranged between the membrane and one of the outer plates.

A fuel cell apparatus is to be understood as meaning a fuel cell assembly in conjunction with a humidification device and if appropriate further supply devices. The fuel cell assembly in this case comprises a multiplicity of planar fuel cells which are stacked on top of one another to form one or more stacks. The fuel cell apparatus may, for example, be a fuel cell block with one or more humidification cell stacks and one or more fuel cell stacks. However, it is also possible for the humidification cells to be arranged at a certain distance from the fuel cells. A stack comprising a mixture of fuel cells and humidification cells is also possible.

The adverse effect of the membrane bearing partially against one of the outer plates on the humidification capacity of the water-permeable membrane can be eliminated by the membrane being arranged suspended freely between the outer plates. However, depending on the material from which the membrane is made, the latter may be so soft and flexible that in operation it will again and again at least partially come to bear against one of the outer plates. With a water-permeable supporting element arranged between the membrane and one of the outer plates, the membrane is held away from the outer plate in the region of the supporting element. Depending on which side of the membrane the supporting element is arranged on, the humidification water penetrates either firstly through the supporting element and then through the membrane or firstly through the membrane and then through the supporting element, and in this way reaches the operating gas which is to be humidified.

The supporting element may, for example, be fixedly connected to the membrane. As a result, the membrane is held in the desired position between the gas space and the humidification water space by the supporting element, which is provided with sufficient rigidity, so that the membrane does not bear against either of the outer plates. In an alternative configuration of the invention, the membrane bears loosely and releasably against the supporting element and is, for example, pressed onto the supporting element by the operating gas pressure or the humidification water pressure. In this way too, the membrane is held in a predetermined position.

It is expedient for the supporting element not to fill the entire gas space or humidification water space, but rather to leave clear part of the space, so that the flow of operating gas or of humidification water through the gas space or humidification water space, respectively, is not disrupted by the supporting element to an extent which would have an adverse effect on operation of the humidification cell.

The membrane is held in a desired position particularly reliably if a supporting element is arranged on each of the two sides of the membrane. Irrespective of whether the membrane is fixedly connected to one or both supporting elements or is clamped releasably between the supporting elements, partial coverage of the membrane by the outer plates is not possible in the region of the supporting elements. This ensures a reliably high humidification capacity for the membrane.

Particularly stable mounting of the membrane and particularly simple assembly of the humidification cell is achieved if the first outer plate, the first supporting element, the membrane, the second supporting element and the second outer plate in each case bear against one another. In this case, the outer plates expediently include passages or stamp formations through which the operating gas or the humidification water can flow along the outer plate and along the supporting element bearing against the outer plate. In this configuration, the humidification cell forms a particularly stable assembly which is substantially pressure-insensitive. This configuration of the invention is particularly suitable in the case of very flat humidification cells with a very flat gas space and/or humidification water space.

The supporting element may, for example, be designed as a woven wire fabric, a braided wire fabric or alternatively as an expanded grid. In this case, however, it should be ensured that a metallic supporting element does not include any sharp edges, which damage the generally soft membrane. A supporting element which is made from a braided fiber fabric or a fiber felt can be produced at particularly low cost and in a form which is not liable to cause mechanical damage to the membrane. Examples of suitable fibers include plastic fibers, cellulose fibers or other fibers which are sufficiently chemically stable with respect to the operating gases.

It has proven particularly advantageous to produce the supporting element from carbon paper. Carbon paper is sufficiently stable even with respect to pure oxygen and pure hydrogen in conjunction with water and, moreover, is sufficiently water-permeable to ensure effective operation of the humidification cell.

A particularly high humidification capacity in the humidification cell is achieved if the supporting element is hydrophilic. A hydrophilic supporting element sucks up the water and passes it particularly effectively to the location where the water evaporates.

If carbon paper is used as supporting element, it is possible to increase the hydrophilicity of the carbon paper, for example by means of a chemical treatment.

The supporting element may completely cover that surface of the membrane which is accessible to the humidification water or the operating gas. However, good support for the membrane is also ensured if the supporting element covers only part of the flat side of the membrane, for example by virtue of the provision of cutouts in the supporting element. This means that the humidification water and operating gas have unimpeded access to the membrane, with the result that the humidification capacity of the humidification cell is increased. However, it should be ensured that the supporting element covers at least half of a flat side of the membrane, since if less than this area is covered, sufficient support for the generally highly flexible membrane is no longer ensured.

In a preferred configuration of the invention, the humidification cell includes a covering device which covers the supporting element in the region of an operating-medium inlet. The operating-medium inlet is the opening of a line or a passage into the gas or humidification water space of the humidification cell, through which, while the humidification cell is operating, operating gas and humidification water—referred to below as operating media—flow into the gas space and the humidification water space, respectively. The operating media therefore flow through an operating-medium inlet into the respective space of the humidification cell. It has been found that, depending on the particular configuration of the operating-medium space, the operating-medium flow out of the operating-medium inlet into the operating gas or humidification water space is disrupted by the supporting element. The operating medium flows out of the operating-medium inlet into the corresponding space at a relatively high velocity and then comes into contact with the supporting element or flows along the supporting element at the relatively high velocity. As a result, turbulence is generated in the operating medium, which slows down the flow of operating medium and increases the flow resistance to the operating medium presented by the humidification cell. The increase in the flow resistance which is brought about by turbulence of this nature can be substantially avoided by means of a covering device which covers the supporting element in the region of an operating-medium inlet. The covering device used may, for example, be a film or foil, a metal coating, a piece of plastic or a small metal sheet which is used to separate the supporting element from the flow of operating medium around an operating-medium inlet. The covering device diverts the operating medium out of the operating-medium inlet into the respective space and ensures that the operating medium flows in the space without significant turbulence being formed.

In an advantageous configuration of the invention, the membrane is made from the same material as the electrolyte from the electrolyte assembly of the fuel cells from the fuel cell apparatus. A polymer known as NAFION produced by DuPont from Wilmington, Del. has proven to be suitable for use as a material of this type. This configuration simplifies production of the humidification cell, since it is possible to employ a material which has already been used in the fuel cell apparatus.

Further simplification during production of the humidification cell can be achieved if the structure of the electrodes is determined by a carrier material, in which case the supporting element is made from the same carrier material. The demands imposed on the electrodes in the fuel cell are very similar to those imposed on the supporting element in the humidification cell: electrodes and supporting elements have to be sufficiently chemically stable with respect to the mixture of operating gases and water and have to be permeable to water and operating gases. Therefore, the electrodes and the supporting element can be made from the same carrier material. The specific properties of the electrodes or of the supporting element are achieved by a further treatment of this carrier material. In this way, by way of example, the braided fiber fabric or the fiber felt for the supporting element is rendered hydrophilic by a chemical treatment. Despite any slightly different production processes which may be employed for the electrodes and the supporting element, the use of the same carrier material for production of the electrodes and of the supporting element simplifies production of the fuel cell apparatus and also reduces costs.

A further advantage of the invention is achieved if the humidification cells include a membrane assembly comprising a membrane and supporting elements arranged on both sides of the membrane, in which case the membrane assembly and the electrolyte assembly are identical in terms of structure and dimensions. In this case, the humidification cell has a similar structure to a fuel cell of the fuel cell apparatus: instead of the electrolyte of the fuel cell, the humidification cell has a membrane, which is expediently made from the same material as the electrolyte. Analogously to the arrangement of the electrodes on the two flat sides of the electrolyte, in the humidification cell the supporting elements are arranged on the two flat sides of the membrane. In this case, however, the supporting elements do not have to be fixedly connected to the membrane, but rather may bear loosely against the membrane. In this case, it is expedient for the supporting elements to include the same carrier material as the electrodes.

A further advantage is achieved by the identical structure of humidification cell and fuel cell in a fuel cell apparatus. This simplifies production of this fuel cell apparatus and makes it easier to standardize. In a fuel cell, the oxidation gas space and the fuel gas space are arranged on either side of the electrolyte assembly. Similarly, in the humidification cell the gas space and the humidification water space are arranged on either side of the membrane assembly. In a similar way to how the fuel cell is delimited by an interconnector plate on both of its flat sides, the humidification cell is delimited by outer plates on both of its flat sides. In this case, it is expedient for the outer plates to be made from the same material and kept in the same form as the interconnector plates of the fuel cell. If identical dimensions are used for the elements of the membrane assembly and the elements of the electrolyte assembly, it is possible to use the same tools and templates when producing the assemblies. This too simplifies production of the fuel cell apparatus considerably.

Production of the fuel cell apparatus is simplified further if the electrolyte assembly and the membrane assembly are surrounded by the same sealing material. The sealing material holds the assemblies in position and ensures that the gas spaces and the humidification water space are closed off in a gastight manner with respect to the surroundings of the fuel cell apparatus.

Planning, designing, producing and assembling the fuel cell apparatus can be simplified by virtue of the external shape and external dimensions of the humidification cells being identical to those of the fuel cells. This makes it possible to standardize production of fuel cells and humidification cells. Moreover, the structure of the fuel cell apparatus is simplified as a result; since the components of the apparatus which surround the cells, such as for example tie rods, piping or a sleeve around the fuel cell apparatus, do not have to be adapted to differing sizes of humidification cells and fuel cells.

Exemplary embodiments of the invention are explained in more detail on the basis of five figures, in which:

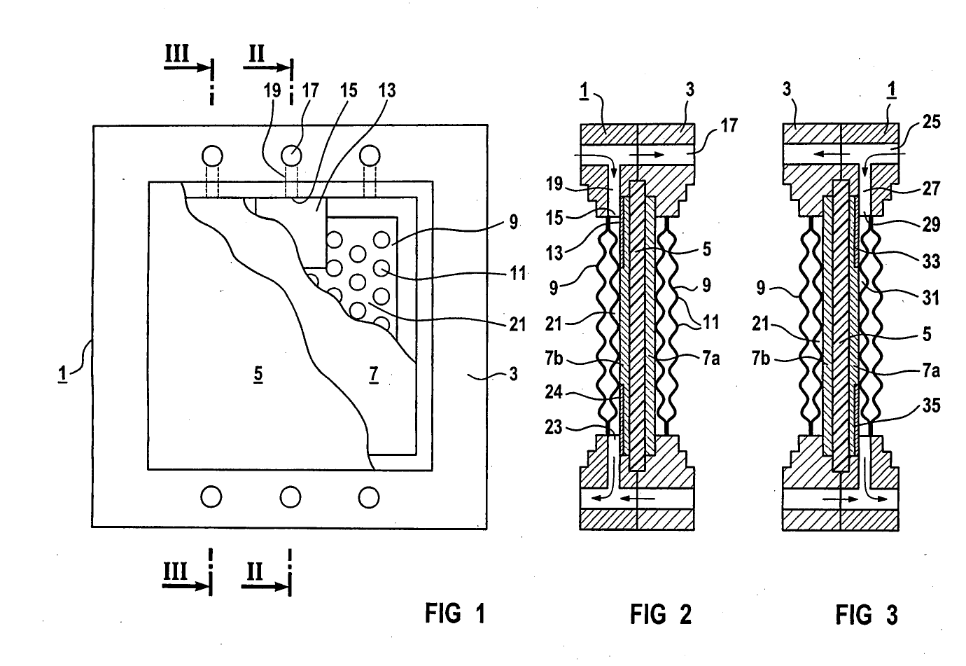

FIG. 1 shows a plan view of a humidification cell which is illustrated in cut-away form;

FIG. 2 shows a section through the humidification cell from FIG. 1;

FIG. 3 shows a further section through the humidification cell;

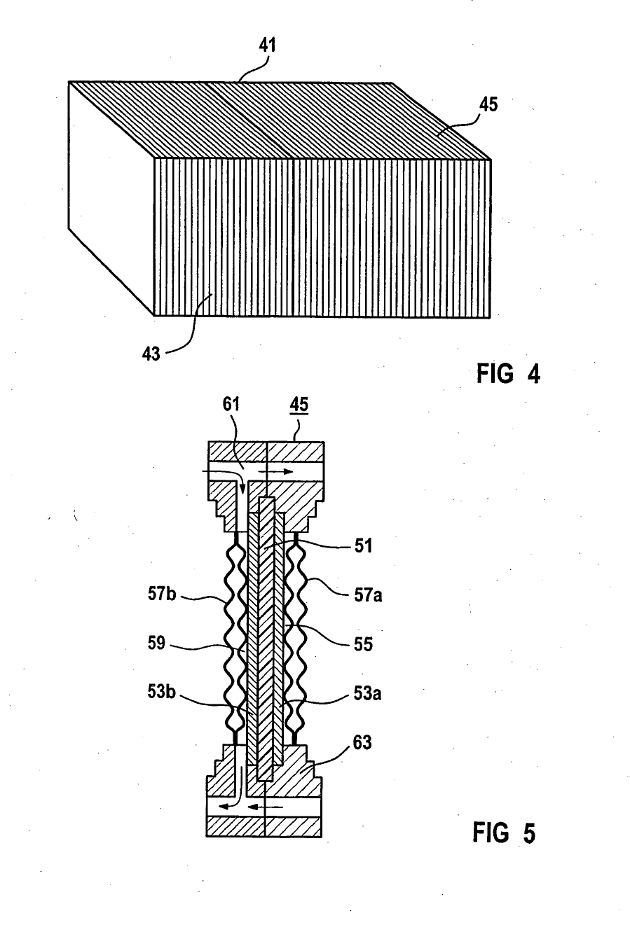

FIG. 4 shows a fuel cell apparatus;

FIG. 5 shows a section through a fuel cell.

Identical elements are provided with identical reference numerals in the figures.

FIG. 1 illustrates a diagrammatic plan view of a rectangular and planar humidification cell 1 which comprises a membrane 5 which is embedded in a frame made from a sealing material 3 and is illustrated in cut-away form. A supporting element 7 is visible beneath the membrane 5, likewise in cut-away form. An outer plate 9, which is configured as a metal sheet with a stamped structure 11, is illustrated beneath the supporting element 7. The stamped structure 11 comprises round elevations or recesses inside the outer plate 9. A covering apparatus 13 is arranged between the outer plate 9 and the supporting element 7. The covering apparatus 13 is arranged in the region of an operating-medium inlet 15.

FIG. 2 shows a section through the humidification cell 1 on line A-A. The humidification cell 1 forms part of a humidification cell stack of a fuel cell apparatus. While the humidification cell 1 is operating, fuel gas flows through the axial passage 17 of the humidification cell 1. The axial passage 17 is oriented parallel to the stack direction of the humidification cell stack. A radial passage 19 in each case branches off from the axial passage 17 to one of the humidification cells 1 of the humidification cell stack. The fuel gas flows through the radial passage 19 and then onward through the operating-medium inlet 15, and then passes into the gas space 21 of the humidification cell 1. After it has emerged from the operating-medium inlet 15, the fuel gas sweeps across the covering device 13, on the one hand, and the outer plate 9 of the humidification cell 1, on the other hand, without forming significant turbulence.

The outer plate 9 is configured as a heating element composed of two metal sheets. Between the metal sheets there is a heating-water space, through which warm heating water flows when the humidification cell 1 is operating. This heating water heats both the fuel gas flowing through the humidification cell 1 and the humidification water to approximately the temperature of the fuel cells of the fuel cell apparatus.

In the gas space 21, the fuel gas is humidified with humidification water and, after it has flowed through the gas space 21, passes to the operating-medium outlet 23 of the gas space 21. By flowing through a further radial passage and a further axial passage, it leaves the humidification cell 1 again in the humidified state. The supporting element 7b is also covered in the region of the operating-medium outlet 23, by a further covering device 24, in order to prevent turbulence as the fuel gas flows into the operating-medium outlet 23.

FIG. 3 shows a section through the humidification cell 1 on line B-B illustrated in FIG. 1. This section runs along an axial passage 25 which carries humidification water while the humidification cell 1 is operating. The humidification water flows through the axial passage 25 and then passes through the radial passage 27 to a further operating-medium inlet 29. By flowing through this operating-medium inlet 29, the humidification water passes into the humidification water space 31 and then flows between the outer plate 9 and a covering device 33. Then, the humidification water passes to the supporting element 7a, which is a carbon paper which has been rendered hydrophilic by a chemical process. Some of the humidification water penetrates through the hydrophilic carbon paper and reaches the membrane 5. After it has passed through this water-permeable membrane 5, the humidification water also penetrates through the further supporting element 7b arranged on the other side of the membrane 5. The humidification water evaporates on that side of the supporting element 7b which faces the gas space 21 and thereby humidifies the fuel gas flowing through the gas space 21. A further proportion of the humidification water flows through the humidification water space 31 unused, sweeps along a further covering device 35 and leaves the humidification cell 1 again after it has flowed through a radial passage and a further axial passage.

The two supporting elements 7a and 7b bear releasably against the water-permeable membrane 5 and cover the flat outer sides of the membrane 5 completely, apart from a narrow outer edge. The two supporting elements 7a and 7b, together with the membrane 5, form a membrane assembly which is clamped between the two outer plates 9 of the humidification cell 1. The supporting elements 7a, 7b therefore bear against the membrane 5 on one side and against one of the outer plates 9 on the other side. The supporting elements 7a, 7b hold the membrane 5 fixedly in position. Moreover, the supporting elements 7a, 7b ensure that the membrane 5 cannot come into contact with the outer plate 9 at any location, which would cause it to become covered by part of the outer plates 9. This means that the humidification water and the operating gas can penetrate through the supporting element 7a to the membrane 5 over substantially the entire area of the membrane 5.

FIG. 4 diagrammatically depicts a fuel cell apparatus 41 in the form of a fuel cell block. The fuel cell apparatus 41 comprises a stack of humidification cells 43 and a stack of fuel cells 45. The humidification cells 43 are of the same width and height as the fuel cells 45. As a result, the fuel cell block has a uniform width and height along the stack direction of the humidification cells 43 and the fuel cells 45 along a stack axis. Moreover, the humidification cells 43 are of the same thickness as the fuel cells 45, which means that the external shape and dimensions of the humidification cells 43 are identical to the external shape and dimensions of the fuel cells 45.

FIG. 5 shows a section through a fuel cell 45 of the fuel cell apparatus 41. The fuel cell 45 comprises an electrolyte 51 and two electrodes 53a and 53b, which are in each case arranged on the flat side of the electrolyte 51. The electrode 53a is adjoined by a fuel gas space 55 which is arranged between the electrode 53a and an interconnector plate 57 of the fuel cell 45. An oxidation gas space 59, which is arranged between the electrode 53b and a further interconnector plate 57b of the fuel cell 45, adjoins the electrode 53b. The interconnector plates 57a and 57b are cooling elements which consist of two metal sheets which between them enclose a cooling water space.

While the fuel cell 45 is operating, cooling water flows through the interconnector plates 57a, 57b in order to cool the fuel cell 45. Oxidation gas flows through an axial passage 61 of the fuel cell 45 and then passes through a radial passage into the oxidation gas space 59.

Both the membrane assembly of the humidification cell 1 and the electrolyte assembly of the fuel cell 45 are surrounded by a frame made from a sealing material 3 or 63, respectively. The sealing material 3 of the humidification cell 1 is the same material as the sealing material 63 of the fuel cell 45. The supporting elements 7a, 7b are also made from the same carrier material as the electrodes 53a, 53b, namely from carbon paper. The carbon paper of the electrodes 53a and 53b, however, unlike the supporting elements 7a and 7b, is also coated with a further material in order to render it hydrophobic. Moreover, on their side facing the electrolyte 51, the electrodes 53a, 53b have a coating of platinum, which serves as a catalyst for the electrochemical reaction within the fuel cell 45. The electrolyte 51, like the water-permeable membrane 5, is made from NAFION. Moreover, the membrane assembly of the humidification cell 1 has the same dimensions as the electrolyte assembly of the fuel cell 45. The similar structure of the fuel cell 45 and the humidification cell 1 means that the number of materials used in the fuel cell apparatus 41 and the number of tools required to produce the fuel cell apparatus 51 are kept at a manageable level. This reduces the production costs of the humidification cell 1 and of the fuel cell apparatus 41.

1. A fuel cell apparatus, comprising:
a plurality of fuel cells, each including an electrolyte assembly arranged between two interconnector plates, the electrolyte assembly including an electrolyte and electrodes arranged on both sides of the electrolyte; and
a plurality of humidification cells including two outer plates, between which a gas space, a humidification water space and a water-permeable membrane separating the two spaces are arranged,
wherein
the humidification cells include a membrane assembly comprising a membrane and supporting elements arranged on both sides of the membrane, with structure and dimensions of the membrane assembly and the electrolyte assembly being identical, wherein
the membrane is made from the same material as the electrolyte, wherein
the structure of the electrodes is defined by a carrier material, with the supporting element being made from the same carrier material, wherein
the outer plates are made from the same material and kept in the same shape as the interconnector plates, and wherein
the external shape and dimensions of the humidification cells are the same as those of the fuel cells (45).

2. The fuel cell apparatus as claimed in claim 1, wherein the supporting element is made from at least one of a braided fiber fabric and a fiber felt.

3. The fuel cell apparatus as claimed in claim 1, wherein the supporting element includes carbon paper.

4. The fuel cell apparatus claimed in claim 1, wherein the supporting element is hydrophilic.

5. The fuel cell apparatus (41) as claimed in claim 1, wherein the supporting element covers at least half of a flat side of the membrane.

6. The fuel cell apparatus as claimed in claim 1, further comprising:
a covering device, adapted to cover the supporting element in the region of an operating-medium inlet.

7. The fuel cell apparatus as claimed in claim 1, wherein the electrolyte assembly and the membrane assembly are enclosed by the same sealing material.

8. The fuel cell apparatus as claimed in claim 2, wherein the supporting element includes carbon paper.

9. The fuel cell apparatus as claimed in claim 2, wherein the supporting element is hydrophilic.

10. The fuel cell apparatus as claimed in claim 3, wherein the supporting element is hydrophilic.

11. The fuel cell apparatus as claimed in claim 8, wherein the supporting element is hydrophilic.

12. The fuel cell apparatus as claimed in claim 2, wherein the supporting element covers at least half of a flat side of the membrane.

13. The fuel cell apparatus as claimed in claim 11, wherein the supporting element covers at least half of a flat side of the membrane.

14. The fuel cell apparatus as claimed in claim 2, further comprising:
a covering device, adapted to cover the supporting element in the region of an operating-medium inlet.

15. The fuel cell apparatus as claimed in claim 13, further comprising:
a covering device, adapted to cover the supporting element in the region of an operating-medium inlet.

16. The fuel cell apparatus as claimed in claim 2, wherein the electrolyte assembly and the membrane assembly are enclosed by the same sealing material.

17. The fuel cell apparatus as claimed in claim 15, wherein the electrolyte assembly and the membrane assembly are enclosed by the same sealing material.

18. A humidification cell for a fuel cell apparatus, comprising:
two outer plates, between which a gas space, a humidification water space and a water-permeable membrane separating the two spaces are arranged; and
a membrane assembly including a membrane and supporting elements arranged on both sides of the membrane, wherein the membrane assembly is structurally and dimensionally similar to an electrolyte assembly of a fuel cell of the apparatus, wherein the membrane is made from the same material as an electrolyte of the fuel cell, and wherein an external shape and dimensions of the humidification cell is the same as that of the fuel cell.

19. The humidification cell as claimed in claim 18, wherein the supporting element is made from at least one of a braided fiber fabric and a fiber felt.

20. The humidification cell as claimed in claim 18, wherein the supporting element includes carbon paper.

21. The humidification cell as claimed in claim 18, wherein the supporting element is hydrophilic.
